(19) United States
(12) Patent Application Publication
(10) Pub. No.: US 2004/0084886 A1
(43) Pub. Date: May 6, 2004

(54) Extendable and contractable steering column apparatus

(75) Inventor: Kou Yamamoto, Gunma-ken (JP)

Correspondence Address: MILES & STOCKBRIDGE PC, 1751 PINNACLE DRIVE, SUITE 500, MCLEAN, VA, 22102-3833, US

(73) Assignee: NSK Ltd.

(21) Appl. No.: 10/694,726

(22) Filed: Oct. 29, 2003

(30) Foreign Application Priority Data
Oct. 30, 2002 (JP) 2002-316606

(51) Int. Cl. B62D 1/18

(52) U.S. Cl. 280/775

(57) ABSTRACT

An extendable and contractable steering column apparatus includes an outer column through which an inner column is slidably inserted, a lock housing portion formed on the outer column, and a locking mechanism that includes a pair of movable pieces slidably fitted within a cylinder bore formed in the lock housing portion. In response to swinging of an operating lever, the locking mechanism shifts the pair of movable piece toward each other so as to press the inner column and to shift the pair of movable pieces away from each other so as to release the pressure on the inner column. The locking mechanism is provided with a threaded screw hole formed in a first movable piece among the pair of movable pieces, a through-hole formed in a second movable piece among the pair of movable pieces, and a screw rod inserted through the through-hole of the second movable piece provided with a screw portion threaded in the threaded screw hole of the first movable piece and a head portion to be in contact with an end surface of the second movable piece and to which a base end portion of the operating lever is fixed.

This application claims the benefit of Japanese Patent Application No. 2002-316606 which is hereby incorporated by reference.

### BACKGROUND OF THE INVENTION

1. Field of the Invention

The present invention relates to a telescopically length adjustable steering column apparatus for adjusting the position of a steering wheel in the length direction of a vehicle by extending and contracting telescopically the whole length of a steering column through which a steering shaft is inserted in accordance with the physical constitution or the position of the driver.

2. Related Background Art

As a steering apparatus for a vehicle, there is a telescopically extendable and contractable steering column apparatus (a so-called telescopic steering column apparatus) for adjusting the position of a steering wheel in the length direction of a vehicle by extending and contracting telescopically the whole length of a steering column, through which a steering shaft is inserted, in accordance with the physical constitution or the position of the driver.

FIG. 3 shows an extendable and contractable steering column apparatus disclosed in Japanese Utility Model Application Laid-Open No. 6-78155 (Japanese Utility Model Registration No. 2588338). In this structure, an outer column 1 is formed as a long tube extending in the axial direction by die cast molding using aluminum or injection molding using a synthetic resin etc. The outer column 1 is supported on the lower portion of the dashboard of a vehicle with integrally molded supporting brackets 2 projecting from both sides of the outer column 1.

Inside the outer column 1, there is inserted an inner column 3 in the form of a long tube extending in the axial direction that can slide in the axial direction. A telescopically extendable and contractable steering shaft 4 is rotatably supported in the interior of the inner column 3.

The lower part of the supporting brackets 2 constitutes a lock housing portion 5 that is integrally molded with the supporting brackets 2. The lock housing portion 5 has a cylinder bore 6 extending through the lock housing portion 5 in the width direction of the vehicle.

A first movable piece 7 is inserted in one of the half portions of the cylinder bore 6 (the right half in FIG. 3) so that the first movable piece 7 can slide in the cylinder bore 6. A first bevel 7a is formed at the upper portion of the first movable piece 7 at a position near the center so that the first bevel 7a presses the outer circumferential surface of the inner column 3.

A second movable piece 8 is inserted in the other half portion of the cylinder bore 6 (the left half in FIG. 3) so that the second movable piece 8 can slide in the cylinder bore 6. A second bevel 8a is formed at the upper portion of the second movable piece 8 at a position near the center so that the second bevel 8a presses the outer circumferential surface of the inner column 3.

A locking mechanism for the first and second movable pieces 7 and 8 has the following structure. The first movable piece 7 has a threaded screw hole 9 having an internal thread. The second movable piece 8 has a through-hole 10 coaxial with the threaded screw hole 9. A screw rod 11 is inserted through the threaded screw hole 9 of the first movable piece 7 and the through-hole 10 of the second movable piece 8.

The screw rod 11 has a screw portion 11a having an external thread to be threaded in the threaded screw hole 9 at one end and an inverse screw portion 11b having an inverse external thread at the other end. The inverse screw portion 11b has a thread with a relatively large pitch such as a double-start thread.

A lock nut 12 is screwed on the portion of the screw rod 11 at one end thereof that projects beyond the outer surface of the first movable piece 7. The lock nut is tightly secured to the outer surface of the first movable piece 7 so as to retain the screw rod non-rotatably. The screw rod has a pair of planar surfaces 13 parallel to each other formed on the outer circumferential surface of the screw rod at the aforementioned end thereof.

A adjusting nut 14 is screwed on the inverse screw portion 11b projecting beyond the outer surface of the second movable piece 8 at the other end of the screw rod 11. A base end portion of an operating lever 15 is connected and fixed to the adjusting nut 14 by welding or the like means.

An compression spring 16 is provided between the first and second movable pieces 7 and 8. With the biasing force of the compression spring 16, both the movable pieces are positively spaced apart from each other upon telescopic adjustment.

In the extendable and contractable steering column apparatus having the above-described structure, when the operating lever 15 is swung in one direction to rotate the adjusting nut 14 in one direction for attaining securing at the telescopically adjusted position, since the adjusting nut 14 is screwed on the inverse screw portion 11b of the non-rotatable screw rod 11, a tensile force acts on the non-rotatable screw rod 11 toward the left in FIG. 3 by the effect of the feed screw mechanism while a reverse force acts on the adjusting nut 14 toward the right in FIG. 3.

Consequently, the non-rotatable screw rod 11 is shifted toward the left in FIG. 3, which causes the first movable piece 7 to shift toward the left in FIG. 3. On the other hand, the second movable piece 8 is shifted in the right in FIG. 3 by the reverse force of the adjusting nut 14. Thus, the first movable piece 7 and the second movable piece 8 are shifted toward each other, so that the bevels 7a and 8a of both the movable pieces 7 and 8 press the outer peripheral surface of the inner column 3. As a result, securing at the telescopically adjusted position can be attained.

On the other hand, upon telescopically adjusting the position of the steering wheel, the operating lever is swung in the direction reverse to the above to rotate the adjusting nut 14 in the reverse direction. Then, a pressing force toward the right in FIG. 3 acts on the non-rotatable screw rod 11 by the effect of the feed screw mechanism, while an reaction force toward the left in FIG. 3 acts on the adjusting nut 14.

Consequently, the non-rotatable screw rod 11 is shifted toward the right in FIG. 3 by a tensile force, which causes the first movable piece 7 to shift toward the right in FIG. 3, while the second movable piece 8 is shifted toward the left in FIG. 3 by a reaction force of the inner column 3. Thus, the first movable piece 7 and the second movable piece 8 are shifted away from each other, so that the bevels 7a and 8a of both the movable pieces 7 and 8 are detached from the outer peripheral surface of the inner column 3. In this process, the compression spring 16 facilitates the shifting away movement of the movable pieces 7 and 8. As a result, securing of the telescopic position is released and telescopic adjustment is allowed.

However, in the structure of the extendable steering column according to Japanese Utility Model Application Laid-Open No. 6-78155 (Japanese Utility Model Registration No. 2588338) shown in FIG. 3, the locking mechanism for the first and second movable pieces 7 and 8 includes two nuts (i.e. the lock nut 12 and the adjusting nut 14) in addition to the screw rod 11. Namely, it includes a significant number of parts, which leads to an increase in the manufacturing cost. Especially, it is desired to omit the two nuts (the lock nut 12 and the adjusting nut 14).

### SUMMARY OF THE INVENTION

The present invention has been made in view of the above-described situation and has an object to provide a telescopically extendable and contractable steering column in which the number of the parts is reduced so that the manufacturing cost can be reduced.

In order to attain the above-described object, a telescopically extendable and contractable steering column apparatus according to the present invention includes an outer column through which an inner column is slidably inserted, a lock housing portion formed on the outer column, and a locking mechanism that includes a pair of movable pieces slidably fitted within a cylinder bore formed in the lock housing portion to shift the pair of movable piece toward each other so as to press the inner column and to shift the pair of movable pieces away from each other so as to release the pressure on the inner column, in response to swinging of an operating lever, wherein the locking mechanism comprising:

a threaded screw hole formed in a first movable piece as one of the pair of movable pieces;

a through-hole formed in a second movable piece as the other of the pair of movable pieces; and

a screw rod inserted through the through-hole of the second movable piece provided with a screw portion threaded in the threaded screw hole of the first movable piece and a head portion to be in contact with an end surface of the second movable piece and to which a base end portion of the operating lever is fixed.

According to the present invention as per the above, since the base end portion of the operating lever is fixed to the head portion of the screw rod, when the operating lever is swung in one direction upon securing at a telescopically adjusted position, the screw rod is rotated in one direction. In this process, since the screw portion of the screw rod is threaded in the threaded screw hole of the first movable piece, as the screw rod is rotated, an tensile force acts on the first movable piece in the direction toward the second movable piece by the effect of the feed screw mechanism, while a reverse force acts on the head portion of the screw rod in the direction for pressing the second movable piece toward the first movable piece.

Consequently, the first movable piece and the second movable piece pressed by the head portion of the screw rod are shifted toward each other so as to press the outer circumferential surface of the inner column. Thus, securing at the adjusted telescopic position can be attained.

On the other hand, upon telescopically adjusting the position of the steering wheel, since the base end portion of the operating lever is fixed to the head portion of the screw rod, when the operating lever is swung in the direction reverse to the above, the screw rod is rotated in the reverse direction. Since the screw portion of the screw rod is threaded in the threaded screw hole, as the screw rod is rotated, an tensile force acts on the first movable piece in the direction away from the second movable piece by the effect of the feed screw mechanism, while a reaction force acts on the head portion of the screw rod in the direction for releasing the pressure on the second movable piece.

Consequently, the first movable piece and the second movable piece (the pressure applied on which by the head portion of the screw rod has been released) are shifted away from each other so as to be detached from the outer peripheral surface of the inner column. Thus, securing of the telescopically adjusted position is released, so that adjustment of the telescopic position is allowed.

With the above-described structure, the number of the parts can be reduced as compared to the prior art structure by omitting the two nuts, so that the manufacturing cost can be reduced.

### BRIEF DESCRIPTION OF THE DRAWINGS

FIG. 1 is a side view showing an extendable and contractable steering column apparatus according to an embodiment of the present invention.

FIG. 2 is an enlarged cross sectional view taken along line II-II in FIG. 1.

FIG. 3 is a cross sectional view showing an extendable and contractable steering column apparatus according to a prior art as disclosed in the aforementioned Japanese Utility Model Application Laid-Open No. 6-78155.

### DESCRIPTION OF THE PREFERRED EMBODIMENT

In the following, a telescopically extendable and contractable steering column apparatus according to an embodiment of the present invention will be described with reference to the annexed drawings.

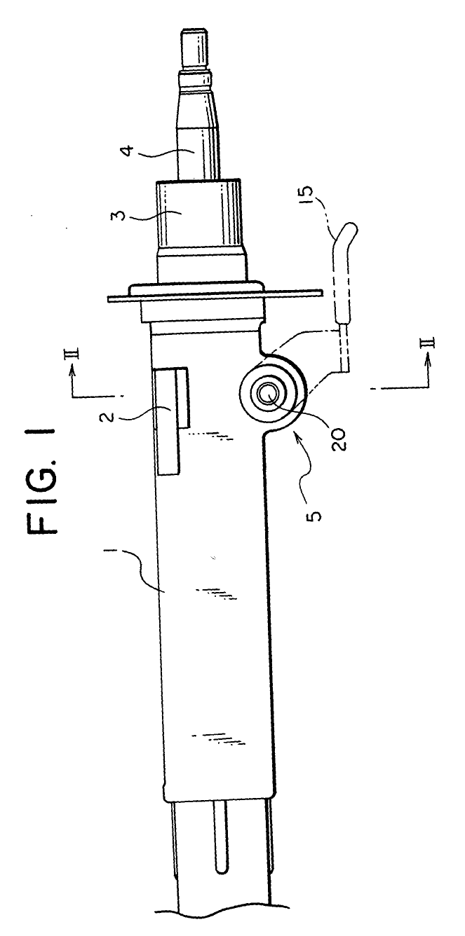

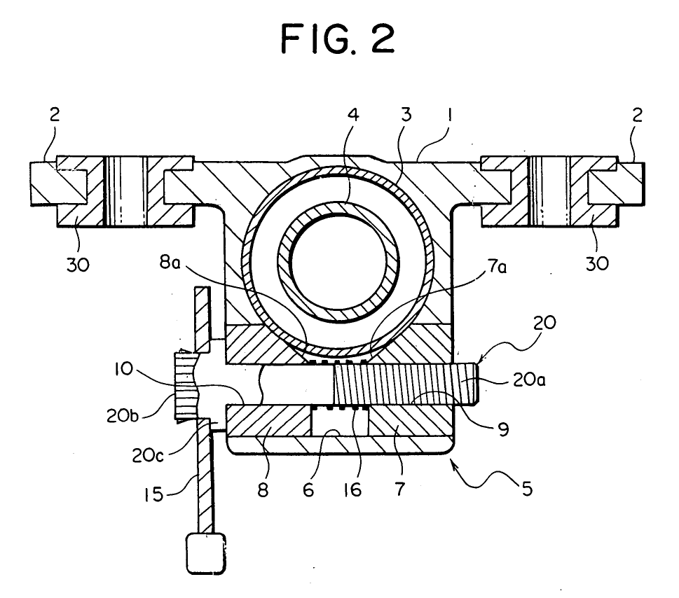

FIG. 1 is a side view showing the extendable and contractable steering column apparatus according to the embodiment of the present invention. FIG. 2 is an enlarged cross sectional view taken along line II-II in FIG. 1.

As shown in FIGS. 1 and 2, an outer column 1 is formed as a long tube extending in the axial direction by die cast molding using aluminum or injection molding using a synthetic resin etc. The outer column 1 is supported on the lower portion of the dashboard of a vehicle with integrally molded supporting brackets 2 projecting from both sides of the outer column 1 by means of bolts (not shown) or the like via resin capsules 30.

Inside the outer column 1, there is inserted an inner column 3 in the form of a long tube extending in the axial direction that can slide in the axial direction. A length adjustable, that is, extendable/contractable steering shaft 4 is rotatably supported in the interior of the inner column 3.

A lock housing portion 5 projecting below the outer column 1 is provided on the lower part of the supporting brackets 2. The lock housing portion 5 is integrally molded with the supporting brackets 2. The lock housing portion 5 has a cylinder bore 6 extending through the lock housing portion 5 in the width direction of the vehicle.

A first movable piece 7 is inserted in one of the half portions of the cylinder bore 6 (the right half in FIG. 2) so that the first movable piece 7 can slide in the cylinder bore 6. A first bevel or an inclined surface 7a is formed at the upper portion of the first movable piece 7 at a position near the center of the lock housing portion 5 so that the first bevel 7a presses the outer circumferential surface of the inner column 3.

A second movable piece 8 is inserted in the other half portion of the cylinder bore 6 (the left half in FIG. 2) so that the second movable piece 8 can slide in the cylinder bore 6. A second bevel or an inclined surface 8a is formed at the upper portion of the second movable piece 8 at a position near the center so that the second bevel 8a presses the outer circumferential surface of the inner column 3.

While the cylinder bore 6 and the movable pieces 7 and 8 have circular cross sections, the shape of the cross section of the cylinder bore 6 may be a non-circular shape such as a polygonal shape (e.g. a triangular shape or a quadrangular shape etc.) or an elliptical shape. The cross sectional shape of each of the movable pieces 7 and 8 may also be a non-circular shape such as a polygonal shape (e.g. a triangular shape or a quadrangular shape etc.) or an elliptical shape correspondingly. The first and second bevels 7a and 8a may be either planer surfaces or curved surfaces that follow the shape of the outer peripheral surface of the inner column 3.

A locking mechanism for the first and second movable pieces 7 and 8 has the following structure.

The first movable piece 7 has a threaded screw hole 9. The second movable piece 8 has a through-hole 10 coaxial with the threaded screw hole 9. A screw rod 20 is inserted in the threaded screw hole 9 of the first movable piece 7 and the through-hole 10 of the second movable piece 8.

The screw rod 20 has a screw portion 20a having an external thread to be threaded in the threaded screw hole 9 at one end (on the right side in FIG. 2). The screw portion 20a has a thread with a relatively large pitch such as a double-start thread.

The base end portion of an operating lever 15 is fixed to the head portion 20b of the screw rod 20. Specifically, a serration is formed on the head portion 20b, and the outer periphery of the head portion 20b is caulked after the base end portion of the operating lever 15 is fitted to the head portion 20b.

The base end portion of the operating lever 15 may be fixed to the head portion 20b in the following alternative manner, besides the above-described way shown in the drawings:

(a) A serration is formed on the head portion 20b and the base end portion of the operating lever 15 is press fitted to the head portion 20b;

(b) A circular hole is formed in the base end portion of the operating lever 15 and the base end portion of the operating lever 15 is press fitted to the head portion 20b;

(c) A circular hole is formed in the base end portion of the operating lever 15 and the outer periphery of the head portion 20b is caulked after the base end portion of the operating lever 15 is fitted to the head portion 20b; or

(d) The base end portion of the operating lever 15 is welded to the head portion 20b.

The head portion 20b of the screw rod 20 has a collar 20c to be in contact with an end surface of the second movable piece 8.

An compression coil spring 16 is provided between the first and second movable pieces 7 and 8. The screw rod 20 passes through the compression spring 16. Upon telescopic adjustment of the position of the steering wheel, both the movable pieces 7 and 8 are positively spaced away from each other by the biasing force of the compression spring 16. The compression spring 16 is not essential to this structure and it may be provided as circumstances demand.

In the extendable and contractable steering column apparatus having the above described structure, since the base end portion of the operating lever 15 is fixed to the head portion 20b of the screw rod 20, when the operating lever 15 is swung in one direction upon securing at a telescopically adjusted position, the screw rod 20 is rotated in one direction. Since the screw portion 20a of the screw rod 20 is threaded in the threaded screw hole 9 of the first movable piece 7, as the screw rod 20 is rotated, a tensile force acts on the first movable piece 7 in the direction toward the second movable piece 8 (i.e. toward the left in FIG. 2) by the effect of the feed screw mechanism. On the other hand, a reverse force acts on the head portion 20b (or the collar 20c) of the screw rod 20 in the direction for pressing the second movable piece 8 toward the first movable piece 7 (i.e. toward the right in FIG. 2).

Consequently, the first movable piece 7 is shifted toward the left in FIG. 2 by the tensile force, while the second movable piece 8 is shifted toward the right in FIG. 2 by the reverse force (or pressing force) exerted by the head portion 20b (or the collar 20c) of the screw rod 20. Thus, the first movable piece 7 and the second movable piece 8 are shifted closer to each other, so that the bevels 7a and 8a of both the movable pieces 7 and 8 press the outer peripheral surface of the inner column 3. As a result, securing at the telescopically adjusted position can be attained.

On the other hand, upon adjusting telescopically the position of the steering wheel, since the base end portion of the operating lever 15 is fixed to the head portion 20b of the screw rod 20, when the operating lever 15 is swung in the direction reverse to the above, the screw rod 20 is rotated in the reverse direction. Since the screw portion 20a of the screw rod 20 is threaded in the threaded screw hole 9, as the screw rod 20 is rotated, a tensile force acts on the first movable piece 7 in the direction away from the second movable piece 8 (i.e. toward the left in FIG. 2) by the effect of the feed screw mechanism. On the other hand, a reverse force acts on the head portion 20b (or the collar 20c) of the screw rod 20 in the direction for releasing the pressure on the second movable piece 8 (i.e. toward the right in FIG. 2).

Consequently, the first movable piece is shifted toward the right in FIG. 2, while the second movable piece 8 is shifted toward the left in FIG. 2. Thus, the first movable piece 7 and the second movable piece 8 are shifted away from each other, so that the bevels 7a and 8a of both the movable pieces 7 and 8 are detached from the outer peripheral surface of the inner column 3. In this process, the compression spring 16 facilitates the shifting away movement of the movable pieces 7 and 8. As a result, securing of the telescopically adjusted position is released, so that telescopic adjustment of the position of the steering wheel is allowed.

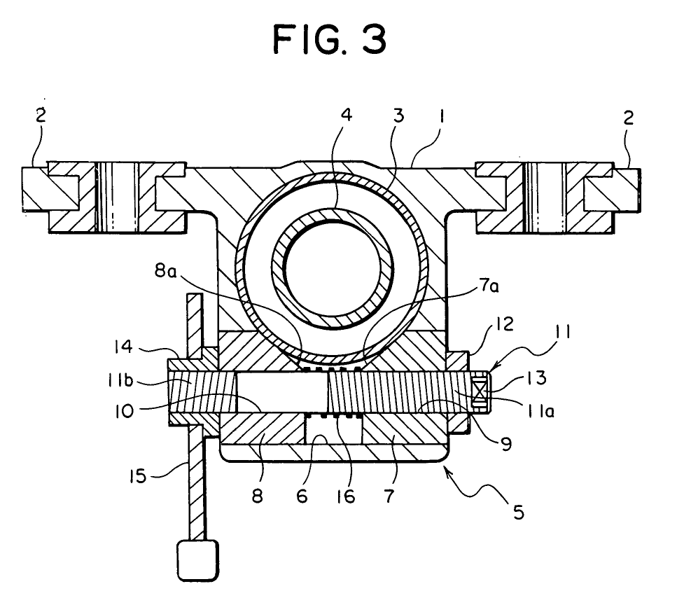

In this structure, since the screw rod 20 is rotated upon telescopic adjustment of the axial position of the steering wheel, the lock nut 12 (in FIG. 3) used in the prior art for retaining the screw rod 11 (in FIG. 3) non-rotatably is not needed.

In addition, the adjusting nut 14 used in the prior art (in FIG. 3) can be omitted, since the operating lever 15 is fixed to the head portion 20b formed on the screw rod 20 and the screw rod 20 is rotated for effecting the feed screw mechanism.

As per the above, the number of the parts can be reduced as compared to the prior art structure by omitting the two nuts, so that the manufacturing cost can be reduced.

It should be noted that the present invention is not limited to the details of the above-described embodiment and various modifications can be made to the embodiment. For example, while the above description of the embodiment has been made in connection with the telescopically length adjustable steering column, the present invention can also be applied to the tilt adjustable and telescopically length adjustable steering column. Furthermore, while in the above-described embodiment the first and second movable pieces 7 and 8 and the screw rod 20 are disposed below the inner column 3, those members may be disposed above the inner column 3.

According to the present invention as per the above, since the base end portion of the operating lever is fixed to the head portion of the screw rod, when the operating lever is swung in one direction upon securing at a telescopically adjusted position, the screw rod is rotated in one direction. In this process, since the screw portion of the screw rod is threaded in the threaded screw hole of the first movable piece, as the screw rod is rotated, an tensile force acts on the first movable piece in the direction toward the second movable piece by the effect of the feed screw mechanism, while a reverse force acts on the head portion of the screw rod in the direction for pressing the second movable piece toward the first movable piece.

Consequently, the first movable piece and the second movable piece pressed by the head portion of the screw rod are shifted toward each other so as to press the outer circumferential surface of the inner column. Thus, securing at the telescopically adjusted position can be attained.

On the other hand, upon telescopically adjusting the position of the steering wheel, since the base end portion of the operating lever is fixed to the head portion of the screw rod, when the operating lever is swung in the direction reverse to the above, the screw rod is rotated in the reverse direction. Since the screw portion of the screw rod is threaded in the threaded screw hole, as the screw rod is rotated, an tensile force acts on the first movable piece in the direction away from the second movable piece by the effect of the feed screw mechanism, while a reverse force acts on the head portion of the screw rod in the direction for releasing the pressure on the second movable piece.

Consequently, the first movable piece and the second movable piece (the pressure applied on which by the head portion of the screw rod has been released) are shifted away from each other so as to be detached from the outer peripheral surface of the inner column. Thus, securing of the telescopically adjusted position is released, so that telescopic adjustment of the axial position of the steering wheel is allowed.

What is claimed is:

1. An extendable and contractable steering column apparatus including an outer column through which an inner column is slidably inserted, a lock housing portion formed on the outer column, and a locking mechanism that includes a pair of movable pieces slidably fitted within a cylinder bore formed in the lock housing portion to shift said pair of movable pieces toward each other so as to press said inner column and to shift said pair of movable pieces away from each other so as to release the pressure on said inner column, in response to swinging of an operating lever, wherein said locking mechanism comprising:
a threaded screw hole formed in a first movable piece as one of said pair of movable pieces;
a through-hole formed in a second movable piece as the other of said pair of movable pieces; and
a screw rod inserted through the through-hole of said second movable piece provided with a screw portion threaded in the threaded screw hole of said first movable piece and a head portion to be in contact with an end surface of said second movable piece and to which a base end portion of said operating lever is fixed.
